(19) United States
(12) Patent Application Publication
(10) Pub. No.: US 2010/0114491 A1
(43) Pub. Date: May 6, 2010

(54) ACTIVATION-DEACTIVATION PROCESS ON THE GROUND FOR AN AIRCRAFT TRAFFIC ALERT AND COLLISION AVOIDANCE SYSTEM

(75) Inventor: Christophe MAILY, Toulouse (FR)

Correspondence Address: OSLER, HOSKIN & HARCOURT LLP (AIRBUS), 1000 DE LA GAUCHETIERE STREET WEST, SUITE 2100, MONTREAL, QC, H3B-4W5, CA

(73) Assignee: AIRBUS OPERATIONS, Toulouse Cedex (FR)

(21) Appl. No.: 12/557,910

(22) Filed: Sep. 11, 2009

(30) Foreign Application Priority Data
Sep. 12, 2008 (FR) 0856170

(51) Int. Cl. G08G 5/04; G08G 5/06; H04B 1/59

(52) U.S. Cl. 701/301

(57) ABSTRACT

An aircraft is equipped with a traffic alert and collision avoidance system. This system includes an interrogating function to interrogate a transponder on-board another aircraft. The interrogating function is activated when the aircraft is on the ground and is located below a distance threshold in relation to a take-off/landing runway. The interrogating function is deactivated when the aircraft is on the ground and one of the two following conditions is met: (i) there is no take-off/landing runway with respect to which the aircraft is located below a distance threshold greater than the distance threshold first mentioned, and (ii) after a wait time following activation, there is no take-off/landing runway with respect to which the aircraft is located below a distance threshold at least equal to the distance threshold first mentioned.

### CROSS-REFERENCE

This application claims priority to French application FR 08 56170, filed on Sep. 12, 2008, the entirety of which is incorporated by reference in this application.

### TECHNICAL DOMAIN OF THE INVENTION

The invention concerns an aircraft traffic alert and collision avoidance system and a process to control such a system. The invention also relates to an aircraft with such a system.

### PRIOR STATE OF THE ART

The TCAS (Traffic Alert and Collision Avoidance System) traffic surveillance systems and mode S transponder generally work in the background on the plane: they are functional, but while no alert is declared, their availability may be transparent for the crew. Because of this, these functions, indispensable for proper management of a flight, must be available whenever the pilot may need them, without so much as worrying about a particular selection.

Classically, the operating mode of current traffic surveillance systems is manually run by the crews. These tasks are carried out by crews for each flight before take-off. This increases the workload of crews during the critical phase of preparing for the flight. Since these surveillance systems generally work in the background, it is possible that the activation step of one or any of the systems can be forgotten. Finally, as with any manual task, the activation of surveillance systems by crew members is susceptible to being forgotten.

In addition, large airports increasingly endure harmful effects linked to the constant increase in traffic and the number of aircrafts in circulation. In fact, considering the frequency of interrogating signals, classically every second, an overload of radio frequencies used by traffic surveillance systems, such as 1030 MHz for interrogating signals and 1090 MHz for responding signals, increasingly risks interfering with the proper functioning of traffic surveillance systems.

### SUMMARY OF THE INVENTION

One aspect of the invention provides for a process to control an aircraft traffic collision avoidance system on-board an aircraft. The aircraft traffic alert and collision avoidance system includes an interrogating function to interrogate a transponder on-board another aircraft. The process includes the following steps:

activation of the interrogating function when the aircraft is on the ground and is located below a distance threshold in relation to a take-off[[-]]/landing runway;

deactivation of the interrogating function when the aircraft is on the ground and one of the two following conditions is met:

(a) there is no take-off/landing runway with respect to which the aircraft is located below a distance threshold greater than the distance threshold first mentioned, and

(b) after a wait time following activation, there is no take-off/landing runway with respect to which the aircraft is located below a distance threshold at least equal to the distance threshold first mentioned.

Another aspect of the invention provides for an aircraft traffic alert and collision avoidance system. The system comprises:

an interrogating function to interrogate a transponder on-board another aircraft; and

a control module designed for deactivation of the interrogating function when one of the two following conditions is met:

(a) there is no take-off/landing runway with respect to which the aircraft is located below a distance threshold greater than the distance threshold first mentioned, and

(b) after a wait time following activation, there is no take-off/landing runway with respect to which the aircraft is located below a distance threshold at least equal to the distance threshold first mentioned.

Yet another aspect of the invention provides for an aircraft that is equipped with such a system.

Also, provisions are made to avoid that the interrogating function of the system teeters between an active and inactive state in an untimely fashion.

In addition, it is not necessary that all of the system alert functions be activated in a quasi-continuous way, from the on-board presence of a flight preparation crew. This allows to considerably reduce the use of radio interrogating and response frequencies, decreasing the overload risk of these frequencies in airports confronted with a lot of traffic.

An automatic process also allows to decrease the actions required of the crew to choose the different modes of operation of traffic surveillance systems. Thus, the crew workload is reduced at the time when there are numerous important actions to execute before the flight. Moreover, the automatic process allows to decrease the risk of forgetting to activate one or any of the surveillance systems by members of the crew. The distance threshold to activate the interrogating function can, for example, be established at 25 m, 50 m, 100 m, or another distance. The position of the aircraft can be obtained by the TCAS or GPS (Global Positioning System) systems or by any other localization process.

The automatic activation of the interrogating function of an alert system allows the aircraft to securely carry out the taxi phases. In addition, when crossing in a runway area, the pilot is notified by the alert system in the case of potential risks. When the crossing is completed, the interrogating function of the alert system is deactivated, avoiding the cluttering of reserved frequencies during displacement phases presenting little risk.

According to an embodiment, geographical data related to the take-off/landing runways are obtained from a database.

According to an embodiment, the database includes at least one of the following databases: (i) a centralized aircraft database, (ii) an EGWPS (Enhanced Ground Proximity Warning System) or TAWS (Terrain Awareness and Warning System) environment surveillance calculator database, (iii) an OANS (On-Board Navigation System) airport navigation calculator database.

According to another embodiment, the detection of a displacement phase of an aircraft launches the activation of a transponder on-board the aircraft.

The transponder is therefore no longer systematically activated in a quasi-continuous way from the on-board presence of a flight preparation crew. This allows to considerably decrease the use of certain frequencies, for example the 1030 MHz and 1090 MHz frequencies.

An embodiment allows to render “electronically visible” aircrafts that it is useful to locate by radar or by any other equipment only, whether it is through the control tower or by other aircrafts, in order to know which aircrafts are in the displacement phase.

In an embodiment, said displacement phase corresponds to the backward movement phase of the aircraft. It is generally the first movement phase of the aircraft before its progression towards the runway area. The mobility cases of the aircraft include mobility on the ground and mobility in flight, in such a way that when the aircraft is in flight, the transponder is always operating.

The transponder is preferably a mode S transponder.

In another alternative, the detection of an operating phase of at least an aircraft engine engages the activation of the transponder on-board the aircraft.

Turning the engines on shortly precedes the displacement phase of the aircraft. In this way, the activation time of the transponder during layover cycles is restricted, without the risk of forgetting activation during displacement phases.

In another alternative, the detection of a shutdown phase of aircraft engines on the ground engages the deactivation of the transponder on-board the aircraft.

According to another embodiment, the traffic alert and collision avoidance system is designed to function in override mode in which the interrogating function is activated and deactivated manually.

This “forced” activation mode allows to preserve the possibility of activation at any time by a member of the crew, for any reason.

### DESCRIPTION OF FIGURES

The invention will be better understood in reading the following description and examining the attached figures, presented in a non restrictive way, in which:

FIG. 1 is a synoptic diagram of an activation-deactivation process on the ground for an aircraft traffic alert and collision avoidance system according to the invention;

FIG. 2 is a schematic representation of an activation-deactivation process on the ground for an aircraft traffic alert and collision avoidance system according to the invention.

### DETAILED DESCRIPTION OF THE INVENTION

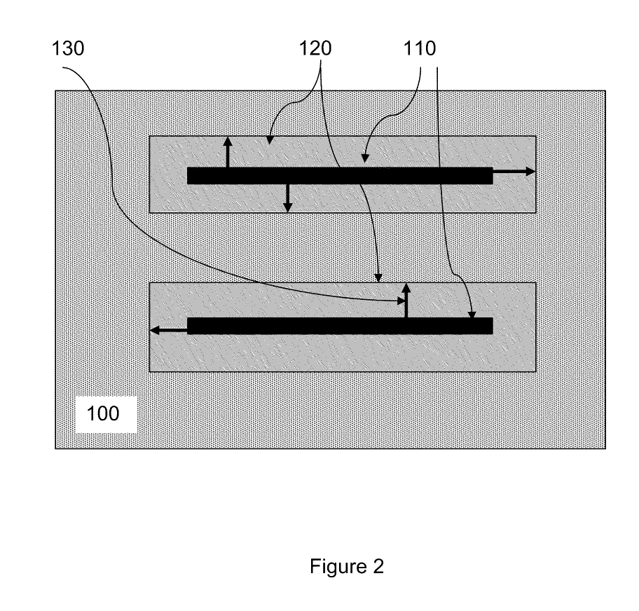

An interrogating function of an alert and collision avoidance system is put into operation when the plane approaches a takeoff/landing runway, and this function is deactivated when the aircraft moves away from the runway. This principle is illustrated in FIG. 2, which shows a portion of an airport site 100, specifically the take-off/landing runways 110 and the areas 120 surrounding these runways 110. Within the areas 120, the alert and collision avoidance system must normally be activated. These areas 120 are defined by a given distance threshold 130 extending around the runways 110. The distance threshold may vary from case to case. For example, the distance threshold 130 could be 25 m, 50 m, 100 m, around a runway or any other value deemed relevant, depending on different criteria such as runway configuration, the space between runways, the intensity of traffic, etc. This distance threshold is not necessarily the same on all sides of the runway, nor for each runway at a given airport site.

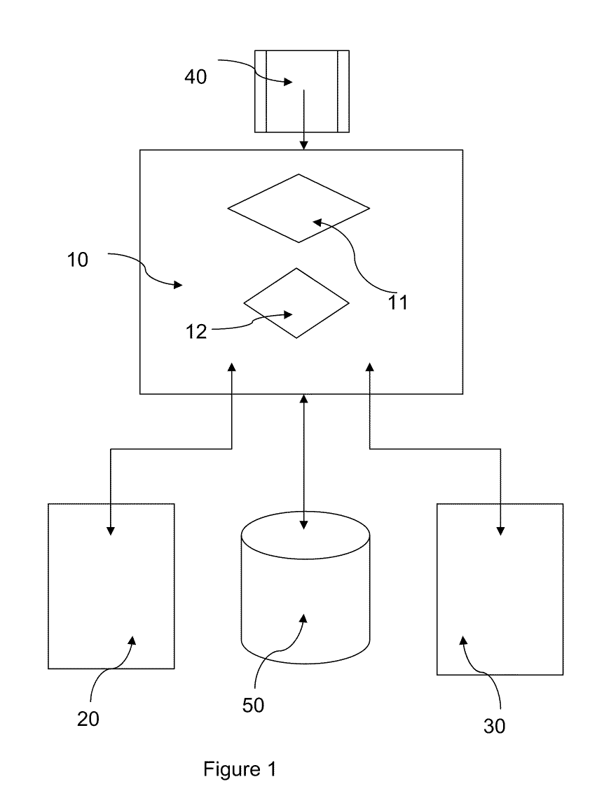

An embodiment of the invention is shown in FIG. 1. A control module 10 of the anti-collision system 20 uses the data 40 concerning the position of the aircraft on the airport site and has access to the data related to the position of take-off/landing runways 50. On the basis of thresholds 130 defined for each runway, the device calculates a corresponding runway area 120. A calculation module 12 determines the distance between the aircraft and the closest runway 120, by comparing the aircraft position data with runway position data. The module verifies or tests the cases of overshooting of the distance threshold 130. This comparison can also be carried out by the activation or deactivation selection module 11 of the anti-collision system. This activation or deactivation selection module 11 is in communication with the alert and collision avoidance system 20. When the aircraft is on the ground, depending on the distance separating it from the closest runway, calculated beforehand by the calculation module 12, said selection module 11 activates or deactivates at least the interrogating function of the anti-collision system 20. That is to say, the anti-collision system 20, can be completely deactivated.

The data related to the runway positions 50 can be obtained from databases. It can be an aircraft centralized database, or a base specifically designed for a given calculator such as a traffic or terrain anti-collision system or any other. According to the embodiment shown in FIG. 2, the localization test of the aircraft on the ground is completed in relation to the different runway areas of the airport site. If the aircraft is at a distance that is below the activation threshold 130, for example 50 m around a runway, the anti-collision system becomes operating. On the contrary, if the airplane is at a distance above the defined threshold, the anti-collision system changes to non-operating mode (“stand-by” or “STBY”).

A principle of hysteresis, or wait time, is implemented, in such a way that the system does not totter between an active state and non activated in an untimely fashion, notably when the plane is located at the limit of a threshold zone. In concrete terms, the control module 10 activates the interrogating function of the anti-collision system 20 when the aircraft is on the ground and is located below a distance threshold in relation to a take-off/landing runway. The control module deactivates the interrogating function when the aircraft is on the ground and one of the two following conditions is met:

(a) there is no take-off/landing runway with respect to which the aircraft is located below a distance threshold greater than the distance threshold first mentioned, and

(b) after a wait time following activation, there is no take-off/landing runway with respect to which the aircraft is located below a distance threshold at least equal to the distance threshold first mentioned.

In deactivating the interrogating function, the control module 10 can also deactivate one or several other functions of the anti-collision system, and even all of the functions of the anti-collision system.

One alternative consists in not using the database integrated in the ground anti-collision system, but in using a generic database (also called the centralized ground database), that is shared by different navigation and surveillance systems, and made available on the centralized server. This way, the information relative to the runways is made available easily and quickly. An example of such a centralized system is described in the French patent application published under number FR 2 908 904.

The aircraft position on the airport site may be obtained from a flight management system such as a FMS (Flight Management System), GPS (Global Positioning System), or generated by a specific algorithm of hybridization between multiple sources.

In another embodiment, integrated architecture is relied upon. Depending on such architecture, one device accommodates several surveillance functions, comprising at least the traffic anti-collision system and the mode S transponder, and potentially the ground anti-collision system.

In the case of implementation on an integrated platform regrouping the traffic and ground anti-collision functions, one can take advantage of the fact that the ground anti-collision system uses data relative to the airport runway positions. Therefore it is possible to transmit to the traffic anti-collision system a Boolean operator (meaning 0 or 1), indicating for example 0 in the case where there is no runway within the proximity (distance threshold not overshot) or 1 in the case of approaching a runway or passing on a runway (distance threshold overshot).

During a flight phase of the aircraft, the anti-collision system should normally be in operating mode.

An alternative embodiment provides for an override mode of the automatic activation process. For example, for the anti-collision system, there are, in addition to the previously described automatic mode, “forced activation” and “forced deactivation” modes. In forced or manual mode, the crew must manually select the desired mode, depending on the context. Preferably, the system returns by default to automatic mode when there is a restart in the surveillance function.

In forced activation mode, the anti-collision system is constrained in operational mode. In this case, regardless of the position of the plane on the airport site, the system is operating. This mode may be used, for example, when the automatic changing mode device does not function well.

In forced or constrained deactivation mode, the anti-collision system is voluntarily interrupted and non-operating, regardless of the position of the plane with respect to the runway. This mode can be used for example in the case of anti-collision system failure, or if malfunctioning is observed.

According to the invention, the process and the device also allow the management of the operating mode (activated or not) of the transponder, particularly the mode S transponder.

When the aircraft is on the ground, the mode S transponder functions if the aircraft moves, or when the engines are turned on.

According to an alternative embodiment, the transponder is only activated when there is a detection of a second engine of the aircraft being turned on. Also, according to this embodiment, with only one functioning engine, without movement of the aircraft, the transponder is in non-operating mode. When the second engine is turned on, whether the aircraft is in motion or not, the transponder switches to operating mode. Finally, if the aircraft is in displacement phase, for example during backward movement, the transponder passes to operating mode.

In flight, the transponder is normally in operating mode.

An override mode of the automatic function is also designed for the mode S transponder. This way, the automatic mode corresponds to the one that was previously described. The mode S transponder is in a mode in which its activation depends on aircraft conditions at a given instant. This automatic mode should be the default mode of use when the aircraft is turned on.

In manual stop mode or forced deactivation, the mode S transponder is manually forced to a non-operational state. This state implies that the equipment is not responding to interrogations and therefore the aircraft is not participating in the anti-collision function with other airplanes. This mode should only be reserved for exceptional cases. To this end, a specific message or procedure can be planned with the manual deactivation phase that alerts the crew when the deactivated transponder mode has been voluntarily chosen.

In “manual start up” mode or “forced activation”, the mode S transponder is forced into operation, regardless of the state of the airplane (in movement or not, engines on or not). This functionality may be launched for example in the case of automatic function failure, or in the case of a particular operational procedure requiring a functioning transponder on the ground while the airplane is at its stagnation point.

The figures and their descriptions above illustrate the invention rather than limit it. In particular, the invention and its different alternatives were just described in relation with examples of specific activation thresholds and in relation with certain types of flight calculators. Nevertheless, it is obvious for a person of the art that the invention can be expanded to other threshold values and for other types of calculators.

The reference signs in the claims have no restrictive character. The verbs “comprise” and “include” do not exclude the presence of other elements than those listed in the claims. The word “one” preceding an element does not exclude the presence of multiples elements.

1. A process to control an on-board aircraft traffic alert and collision avoidance system, the traffic alert and collision avoidance system comprises an interrogating function to interrogate a transponder on-board another aircraft, the process comprising:
activation of the interrogating function when the aircraft is on the ground and is located below a distance threshold with respect to a take-off/landing runway;
deactivation of the interrogating function when the aircraft is on the ground and one of the two following conditions is met:
(a) there is no take-off/landing runway with respect to which the aircraft is located below a distance threshold greater than the distance threshold first mentioned, and
(b) after a wait time following activation, there is no take-off/landing runway with respect to which the aircraft is located below a distance threshold at least equal to the distance threshold first mentioned.

2. A process according to claim 1, in which geographical data related to the take-off/landing runway is obtained from a database.

3. A process according to claim 2, in which the database includes at least one of the following databases: (i) a centralized aircraft database, (ii) an EGWPS (Enhanced Ground Proximity Warning System) or TAWS (Terrain Awareness and Warning System) environment surveillance calculator database, and (iii) an OANS (On-Board Navigation System) airport navigation calculator database.

4. A process according to claim 1, in which detection of a displacement phase of an aircraft launches activation of a transponder on-board the aircraft.

5. A process according to claim 1, in which detection of an operating phase of at least an aircraft engine engages activation of the a transponder on-board the aircraft.

6. A process according to claim 1, in which the detection of a shutdown phase of the engines of the aircraft launches the deactivation of a transponder on-board the aircraft.

7. An aircraft traffic alert and collision avoidance system, the system comprising:
an interrogating function to interrogate a transponder on-board another aircraft; and
a control module designed to activate the interrogating function when the aircraft is on the ground and is located below the distance threshold with respect to a take-off/landing runway, and to deactivate the interrogating function when one of the two following conditions is met:
(a) there is no take-off/landing runway with respect to which the aircraft is located below a distance threshold greater than the distance threshold first mentioned, and
(b) after a wait time following activation, there is no take-off/landing runway with respect to which the aircraft is located below a distance threshold at least equal to the distance threshold first mentioned.

8. A system according to claim 7, the system being designed to function in an override mode in which the interrogation function is activated and deactivated manually.

9. A system according to claim 7, the system being designed to obtain geographical data related to the take-off/landing runway from a database.

10. A system according to claim 9, in which the database includes at least one of the following databases: (i) a centralized aircraft database, (ii) an EGWPS (Enhanced Ground Proximity Warning System) or TAWS (Terrain Awareness and Warning System) environment surveillance calculator database, and (iii) an OANS (On-Board Navigation System) airport navigation calculator database.

11. A system according to claim 7, the system being designed to launch activation of a transponder on-board the aircraft in response to detecting a displacement phase of the aircraft.

12. A system according to claim 7, the system being designed to launch activation of a transponder on-board the aircraft in response to detecting an operating phase of at least one aircraft engine.

13. A system according to claim 7, the system being designed to launch deactivation of a transponder on-board the aircraft in response to detecting an engine shutdown phase of the aircraft.

14. An aircraft with a traffic alert and collision avoidance system, the system comprising:
an interrogating function to interrogate a transponder on-board another aircraft; and
a control module designed to activate the interrogating function when the aircraft is on the ground and is located below the distance threshold with respect to a take-off/landing runway, and to deactivate the interrogating function when one of the two following conditions is met:
(a) there is no take-off/landing runway with respect to which the aircraft is located below a distance threshold greater than the distance threshold first mentioned, and
(b) after a wait time following activation, there is no take-off/landing runway with respect to which the aircraft is located below a distance threshold at least equal to the distance threshold first mentioned.

15. An aircraft with a system according to claim 14, the system being designed to function in an override mode in which the interrogation function is activated and deactivated manually.

16. An aircraft with a system according to claim 14, the system being designed to obtain geographical data related to the take-off/landing runway from a database.

17. An aircraft with a system according to claim 16, in which the database includes at least one of the following databases: (i) a centralized aircraft database, (ii) an EGWPS (Enhanced Ground Proximity Warning System) or TAWS (Terrain Awareness and Warning System) environment surveillance calculator database, and (iii) an OANS (On-Board Navigation System) airport navigation calculator database.

18. An aircraft with a system according to claim 14, the system being designed to launch activation of a transponder on-board the aircraft in response to detecting a displacement phase of the aircraft.

19. An aircraft with a system according to claim 14, the system being designed to launch activation of a transponder on-board the aircraft in response to of detecting an operating phase of at least one aircraft engine.

20. An aircraft according to claim 14, the system being designed to launch deactivation of a transponder on-board the aircraft in response to of detecting an engine shutdown phase of the aircraft.
